(19) United States
(12) Patent Application Publication
(10) Pub. No.: US 2025/0338805 A1
(43) Pub. Date: Nov. 6, 2025

(54) GROW TOWER FOR HYDROPONIC CULTIVATION

(71) Applicant: URBAN KISAAN FARMS PRIVATE LIMITED [IN]/[IN], Hyderabad (IN)

(72) Inventors: Vihari Naga KANUKOLLU, Hyderabad (IN); Sairam PALICHERLA REDDY, Hyderabad (IN); Rambabu POGIRI, Hyderabad (IN)

(73) Assignee: URBAN KISAAN FARMS PRIVATE LIMITED [IN]/[IN], Hyderabad (IN)

(21) Appl. No.: 19/215,467

(22) Filed: May 22, 2025

(30) Foreign Application Priority Data
Nov. 22, 2022 (WO) PCT/IN2023/051074

(51) Int. Cl. A01G 31/02; A01G 7/04

(52) U.S. Cl. CPC A01G 31/025; A01G 7/045

(57) ABSTRACT

The present invention provides a grow tower for cultivation of hydroponics. The present invention relates to a multilayered grow tower for cultivation of hydroponics that enables ambient light to reach to bottom most layers of the tower while occupying lesser floor area. The layers of the grow tower are designed in a manner that the bottom most layer is not shadowed at any point of time while the hydroponic yield from the grow tower is not compromised.

### CROSS-REFERENCE TO RELATED APPLICATIONS

This patent application claims the priority of the Indian Provisional Patent Application filed on 22 Nov. 2022, with the number 202241066963, which was also filed as PCT/IN2023/051074.

### FEDERALLY SPONSORED RESEARCH AND DEVELOPMENT

Not applicable

### FIELD OF INVENTION

The present invention is generally related to a grow tower for cultivation of hydroponics. The present invention is particularly related to a multilayered grow tower for cultivation of hydroponics.

### BACKGROUND OF THE INVENTION

Hydroponic cultivation is increasing and there is a rise in sale of plants and vegetables grown hydroponically. Hydroponic cultivation allows growers to produce food with lesser area and time constraints and enables higher yields with fewer resources. Many plants are grown hydroponically, include tomatoes, peppers, lettuce, greens like spinach and kale, strawberries, basil, thyme and others.

Conventionally, hydroponic cultivation is done on two types of towers; horizontal and vertical. With horizontal cultivation, all plants receive ambient light though the floor area occupied is higher and with yields lower than vertical cultivation. Vertical cultivation on the other hand, requires lesser floor area but the lower layers receive less ambient light resulting in lesser yields.

The abovementioned shortcomings, disadvantages and problems are addressed herein, which will be understood by reading and studying the following specification.

### SUMMARY OF THE INVENTION

The primary object of the present invention is to provide a system for hydroponic cultivation with higher yield and lesser floor area requirement.

Another object of the present invention is to provide a grow tower that enables receipt of optimum light to lower layers of the tower apart from the layers at the top.

Another object of the present invention is to arrange the layers in a manner such that the upper layers cast minimum or no shadow on the lower layers.

Yet another object of the present invention is to provide a portable multilayered grow tower that has the capacity to hold multiple NFTs channels.

Yet another object of the present invention is to provide a grow tower that is detachable and can be reassembled.

These and other objects and advantages of the present invention will become readily apparent from the following detailed description taken in conjunction with the accompanying drawings.

The various embodiments of the present invention provide a grow tower for cultivation of hydroponics. The embodiments provide a multilayered grow tower that enables ambient to reach the bottom most layers and requires lesser floor area, thus not compromising on the yield.

According to one embodiment of the present invention, a grow tower for hydroponic cultivation is provided. The tower is designed such that the hydroponic yield is maximized utilizing lesser floor area while the ambient light reaches the bottom most layers of the grow tower. The grow tower has multiple layers. In one embodiment the grow tower can hold more than 20 layers. In one embodiment the layers from top to bottom are of varying width.

According to one embodiment of the present invention, a grow tower system is provided for enabling hydroponic cultivation. The system includes a supporting frame comprising a plurality of vertically oriented rods and a plurality of horizontally oriented rods. The horizontally oriented rods include those at the base, towards the top, and between the top and base rods. The system also includes a plurality of layers supported by mechanical couplings on the supporting frame, wherein the layers comprise a topmost layer (101), a second layer from the top (102), a third layer from the top (103), and a bottommost layer (104). The plurality of layers are configured with varying widths, wherein the width of the topmost layer is designed to accommodate up to four Nutrient Film Technique (NFT) channels. The width of the second layer is at least 1.5 times that of the topmost layer and configured to accommodate at least six NFT channels. The width of the third layer (103) is at least half that of the second layer and capable of accommodating up to three NFTs. The bottom most layer (104) is at least double the width of the top-most (101) layer and configured to accommodate at least eight NFT channels.

According to one embodiment of the present invention, the vertically oriented rods in the supporting frame are connected to rods or brackets oriented perpendicularly to support the layers onto which NFT channels are seated. The frame comprises rods made from a material selected from metal or metal alloys. In one embodiment, the material is steel with powder coating. In one embodiment, the material is steel without power coating or galvanization. The mechanical couplings for holding the layers on the supporting frame are selected from screws, clamping grooves, nuts, and bolts. The layers are arranged in a manner such that the upper layers cast minimum shadow on the lower layers, ensuring that ambient light reaches the bottommost layer. The second and third layers are arranged in a manner such that the third layer is placed only on the inside of half of the tower to prevent casting shadows on the lower layers.

According to one embodiment of the present invention, the grow tower system for enabling hydroponic cultivation is portable and detachable, allowing for disassembly and reassembly. The grow tower is connected to a power source and a plurality of light sources to provide supplementary light for hydroponic cultivation.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The other objects, features and advantages will occur to those skilled in the art from the following description of the preferred embodiment and the accompanying drawings in which:

FIG. 1 illustrates the isometric view of the grow tower encompassed by the invention. Base (100), support for holding/placing layer 1(101), support for holding/placing the second layer from the top (102), support for holding third layer (103) from the top, support for holding/placing the base layer (104).

FIG. 2 illustrates the side view of the grow tower and comprises the frame, topmost layer, second layer, third layer and the bottom most or the base layer.

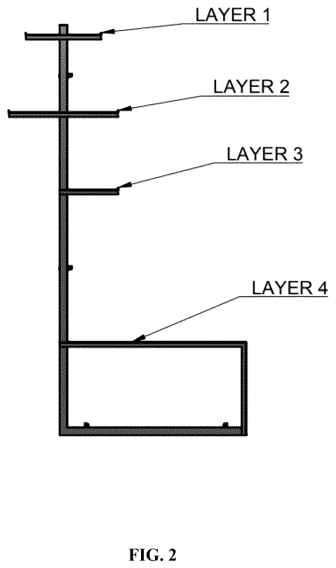

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a grow tower for cultivation of hydroponics. The embodiments provide a multilayered grow tower for hydroponic cultivation.

As used herein, NFTs (Nutrient Film Technique) refers to a recirculating hydroponic system that consists of growing channels over which a nutrient solution is pumped across, creating a nutrient film into which the roots grow. The terms “NFTs” and “NFT channels” is used interchangeably herewith.

According to one embodiment of the present invention, a grow tower for hydroponic cultivation is provided. The grow tower is designed to comprise multiple layers. The grow tower is designed to comprise at least four layers, a supporting frame (100). In one embodiment the grow tower comprises a plurality of mechanical couplings to support the layers onto which the NFT channels are supported. In one embodiment, the grow tower is connected to a power source, and one or more light sources.

According to one embodiment of the present invention, the grow tower has multiple layers. The distance between the layers is designed in a manner such that the upper layers casts minimum or no shadow on the lower layers. The width of the layers is designed such that upper layer casts minimum shadow on the lower layers. The upper layers narrow the shadow on the lower layers. According to one embodiment distance between the layers is in the range of 30-50 cm. According to one embodiment distance between the layers is in the range of 30-40 cm.

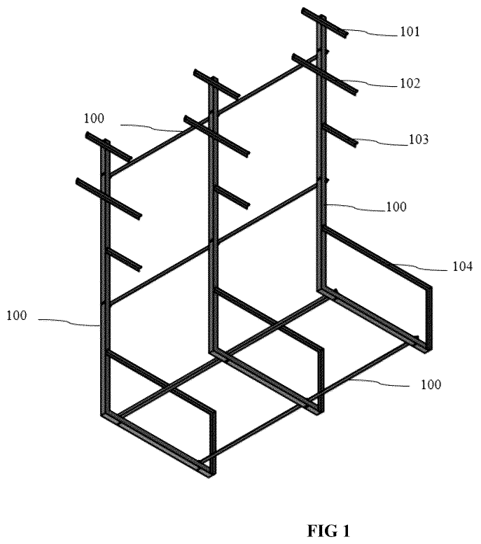

According to one embodiment of the present invention, the grow tower for hydroponic cultivation has four layers. The distance between the layers is designed in a manner such that the upper layers casts minimum or no shadow on the lower layers. The width of the layers is designed such that upper layer casts minimum shadow on the lower layers. The second (102) and third (103) layers of the are designed in a manner such that the third layer is placed only on the inside of half of the tower as shown in FIG. 1 (isometric view). This arrangement of the second (102) and third (103) layers prevents the casting of shadow on the lower layers. The third layer (103) is placed parallelly to the fourth layer. The fourth or the bottom most layer (104) receives no shadow at any point of time. In one embodiment the fourth or bottom most layer (104) received minimal or no shadow. The second layer from the top has the width that is 1.5 times that of the first or topmost layer. The first or the top most layer (101) has the width to accommodate up to four NFT channels while the second layer (102) has the width to accommodate at least than six NFT channels. The third layer (103) has half the width of the second layer. The third layer (103) can accommodate up to three NFTs. The fourth or the bottom most (104) layer has the capacity to accommodate 8 or more NFT channels. The fourth layer is double the width of the topmost layer. The grow tower can accommodate more than 20 NFT channels. The grow tower can accommodate 21 NFT channels. In one embodiment, the top most (101) layer designed to accommodate up to four NFTs channels, the second layer (102) is designed to accommodate at least six NFT channels, the third layer (103) is designed to accommodate up to three NFT channels and the bottom most layer (104) is designed to accommodate at least eight NFT channels.In one embodiment, the top most (101) layer is designed to accommodate four NFT channels, with two NFT channels on each side of the frame (100) and wherein the second layer (102) is designed to accommodate six NFT channels, with three NFT channels on each side of the frame (100).

In one embodiment, the NFT channels are of uniform dimension. In one embodiment the dimensions of an NFT channels are 100 mm×50 mm.

According to one embodiment, the grow tower is comprises of a supporting frame (100), wherein the frame comprises of a plurality of rods oriented vertically. The grow tower comprises of plurality of rods oriented horizontally, including at the base, towards the top and between the top and the base rods. The rods oriented vertically and horizontally are held together by mechanical couplings. In one embodiment the couplings are selected from screws, clamping grooves, nuts and bolts.

The vertically oriented rods comprised in the frame are connected to rods/brackets oriented in a perpendicular manner to support the multiple layers onto which NFT channels are seated.

According to one embodiment of the present invention, the frame comprised in the grow tower to hold the NFT channel is made from materials selected from metal or metal alloys. In one embodiment, the material is steel. In one embodiment the material is steel with powder coating. In one embodiment the material is steel without powder coating or galvanization.

According to one embodiment the grow channel is movable and dismountable.

Although the embodiments herein are described with various specific embodiments, it will be obvious for a person skilled in the art to practice the embodiments herein with modifications.

### Advantages of the Invention

The various embodiments of the present invention provide a tower is designed such that the yield is maximized while utilizing lesser floor area while the ambient light reaches the bottom most layers of the grow tower. The grow tower has multiple layers. In one embodiment the grow tower can hold more than 20 NFT channels.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A grow tower system for enabling hydroponic cultivation, the system comprising:
a supporting frame (100) comprising a plurality of vertically oriented rods and a plurality of horizontally oriented rods, wherein the horizontally oriented rods include those at the base, towards the top, and between the top and base rods; and,
a plurality of layers supported by mechanical couplings on the supporting frame, wherein the layers comprise a topmost layer (101), a second layer (102) from the top, a third layer (103) from the top, and a bottommost layer (104);
wherein, the plurality of layers are configured with varying widths, wherein, the width of the second layer (102) is at least 1.5 times that of the topmost layer (101) and the width of the third layer (103) is at least half that of the second layer and wherein, the bottommost layer (104) is at least double the width of the top-most layer (101).

2. The system of claim 1, the top most (101) layer designed to accommodate up to four NFTs channels,the second layer (102) is designed to accommodate at least six NFT channels, the third layer (103) is designed to accommodate up to three NFT channels and the bottom most layer (104) is designed to accommodate at least eight NFT channels.

3. The system of claim 1, wherein the top most (101) layer is designed to accommodate four NFT channels, with two NFT channels on each side of the frame (100) and wherein the second layer (102) is designed to accommodate six NFT channels, with three NFT channels on each side of the frame (100).

4. The system according to claim 1, wherein the vertically oriented rods in the supporting frame are connected to rods or brackets oriented perpendicularly to support the layers onto which NFT channels are seated.

5. The system according to claim 1, wherein the frame comprises rods made from a material selected from metal or metal alloys.

6. The system of claim 5 wherein the metal is steel with or without powder coating.

7. The system according to claim 1, wherein the mechanical couplings for holding the layers on the supporting frame are selected from screws, clamping grooves, nuts, and bolts.

8. The system according to claim 1, wherein the layers are arranged in a manner such that the upper layers cast minimum shadow on the lower layers, ensuring that ambient light reaches the bottommost layer, and wherein, the second and third layers are arranged in a manner such that the third layer is placed only on the inside of half of the tower to prevent casting shadows on the lower layers.

9. The system according to claim 1, wherein the grow tower system for enabling hydroponic cultivation is portable and detachable, allowing for disassembly and reassembly.

10. The method according to claim 1, wherein the grow tower is connected to a power source and a plurality of light sources to provide supplementary light for hydroponic cultivation.
